(19) United States
(12) Patent Application Publication
(10) Pub. No.: US 2026/0106389 A1
(43) Pub. Date: Apr. 16, 2026

(54) CABLE CONNECTOR

(71) Applicant: ACES ELECTRONICS CO., LTD., Taoyuan (TW)

(72) Inventor: Yi-Guang LAI, Taoyuan (TW)

(21) Appl. No.: 19/043,994

(22) Filed: Feb. 3, 2025

(30) Foreign Application Priority Data
Oct. 11, 2024 (TW) 113210976

(51) Int. Cl. H01R 12/53; H01R 12/72; H01R 13/502; H01R 13/629

(52) U.S. Cl. CPC H01R 12/53; H01R 12/725; H01R 13/502; H01R 13/629

(57) ABSTRACT

A cable connector includes an electrical module and a clamping shell mounted in an insulating housing. The clamping shell is composed of a cover with an upper adhesive stopper and a support plate with a lower adhesive stopper and defines a filling area therein for an adhesive to be filled and cured to cover and fix cables that are bonded to solder pads of the circuit board of the electrical module, so that the upper adhesive stopper and the lower adhesive stopper are used to prevent the adhesive covering and fixing the cables bonded to the solder pads from overflowing forward. Furthermore, a hollow area is formed inside the insulating housing at the welding position of the circuit board and the cables in front of the upper adhesive stopper and the lower adhesive stopper.

This application claims the priority benefit of Taiwan patent application number 113210976, filed on Oct. 11, 2024.

### BACKGROUND OF THE INVENTION

### 1. Field of the Invention

The present invention relates to a cable connector, and more particularly to a cable connector in which when the clamping shell of the cable connector is inserted into an insulating housing for assembly, an upper adhesive stopper and a lower adhesive stopper provided by a cover and a support plate abut against the outside of a plurality of cables to form a sealing structure capable of preventing the adhesive of the insert molding method from overflowing forward, so that the plurality of cables in the filling area behind the upper adhesive stopper and the lower adhesive stopper can be fixed by the cured adhesive, and the fixed cables have the effect of improving near-end crosstalk and far-end crosstalk problems, and the welding position of the circuit board and the plurality of cables in front of the upper adhesive stopper and the lower adhesive stopper form a hollow area and reserve the area where the signal wire cores are in contact with the air, so as to control the impedance matching of the electrical connector and reduce the transmission signal attenuation value caused by insertion loss and return loss.

### 2. Description of the Related Art

Nowadays, the electronics industry is growing rapidly and maturing. Many different 3C functional electronic products are developed and manufactured according to different needs. In particular, the speed at which computers, laptops, tablets and smartphones overlap is beyond imagination. The direction of the update is nothing more than processor computing speed, network transmission speed and lighter, thinner, shorter and smaller size. In addition to being smaller in size, electronic products also need to be equipped with different interface connectors to accommodate the expansion of more functions.

Furthermore, the miniaturization of electronic products is largely due to the advancement of wafer manufacturing processes. When circuit boards and corresponding connectors are miniaturized, the distance between terminals of the terminal set becomes too close, and electromagnetic waves and cross-talk interference are generated when transmitting high-frequency signals. The cross-talk interference problem has an absolute impact on the transmission signal speed. The high-frequency cable connector includes an insulating housing, differential signal wire cores installed in the insulating housing, and ground wire cores adjacent to the differential signal wire cores. The distance between each two traces of the differential signal wire cores must be kept consistent throughout the entire trace. Otherwise, the distance change will cause unbalanced magnetic field coupling, thereby reducing the effect of magnetic field elimination and causing increased electromagnetic interference (EMI). The biggest impact of the increase in electromagnetic interference is that it increases the transmission signal attenuation value of the differential signal wire cores, thereby reducing the speed of the transmission signal of the differential signal wire cores. Furthermore, if the differential signal wire cores are covered with plastic, the resulting insertion loss and reflection loss may also increase the transmission signal attenuation value. The above-mentioned problems have caused the poor overall impedance matching of the electrical connector, and it is yet to be solved by the industry.

### SUMMARY OF THE INVENTION

Therefore, in view of the above problems and deficiencies, the inventor collected relevant information and, after multiple evaluations and considerations, designed the invention of this cable connector.

The main object of the present invention is to provide an cable connector, which comprises an insulating housing with a storage chamber defined therein, an electrical module mounted in the storage chamber and a clamping shell mounted in the storage chamber and located outside the electrical module. The electrical module comprises a circuit board. The circuit board is provided with a plurality of contacts and a plurality of solder pads on both sides of at least one surface thereof. The plurality of solder pads are used for soldering wire cores of a plurality of cables. The clamping shell comprises a cover located at a top side and a support plate located at an opposing bottom side and combined with the cover. The cover comprises an upper adhesive stopper on an inner side thereof. The support plate comprises a lower adhesive stopper on an inner side thereof. The upper adhesive stopper and the lower adhesive stopper define a filling area at the back side thereof for an adhesive to be filled and cured to cover and fix the plurality of cables that are bonded to the plurality of solder pads. The upper adhesive stopper and the lower adhesive stopper are used to prevent the adhesive covering and fixing the plurality of cables bonded to the plurality of solder pads from overflowing forward.

Through the above, when the clamping shell of the cable connector is inserted into the insulating housing for assembly, the upper adhesive stopper and the lower adhesive stopper provided by the cover and the support plate abut against the outside of the plurality of cables to form a sealing structure that can prevent the adhesive of the insert molding method from overflowing forward, so that the cables in the filling area behind the upper adhesive stopper and the lower adhesive stopper can be fixed by the cured adhesive. The fixed cables have the effect of improving near-end crosstalk and far-end crosstalk problems. The welding position of the circuit board and the plurality of cables in front of the upper adhesive stopper and the lower adhesive stopper form a hollow area and reserve the area where the signal wire cores are in contact with the air, so as to control the impedance matching of the electrical connector and reduce the transmission signal attenuation value caused by insertion loss and return loss.

Preferably, the filling area is provided with a plurality of ribs in a block or strip shape to increase the adhesion of the adhesive.

Preferably, the insulating housing further comprises a pouring port located on each of two opposite sides thereof; the cover further comprises a passage located on each of two opposite sides thereof in communication with the respective pouring port for the adhesive to be injected into the filling area by an insert molding method.

Preferably, the insulating housing and the cover are connected and fixed together through at least one fixing groove on the top side of the insulating housing and at least one buckle on the top side of the cover; the cover and the support plate are connected and fixed together through slots on both sides of the cover and the blocks on both sides of the support plate; the insulating housing and the support plate are connected and fixed to each other through at least one buckle groove on the bottom side of the insulating housing and at least one buckle block on the bottom side of the supporting plate.

### BRIEF DESCRIPTION OF THE DRAWINGS

FIG. 1 is a three-dimensional external view of the cable connector of the present invention.

FIG. 2 is a three-dimensional external view of the cable connector of the present invention from another viewing angle.

FIG. 3 is a three-dimensional exploded view of the cable connector of the present invention.

FIG. 4 is a three-dimensional exploded view of the cable connector of the present invention from another viewing angle.

FIG. 5 is a side cross-sectional view of the cable connector of the present invention.

FIG. 6 is another side cross-sectional view of the cable connector of the present invention.

### DETAILED DESCRIPTION OF THE PREFERRED EMBODIMENT

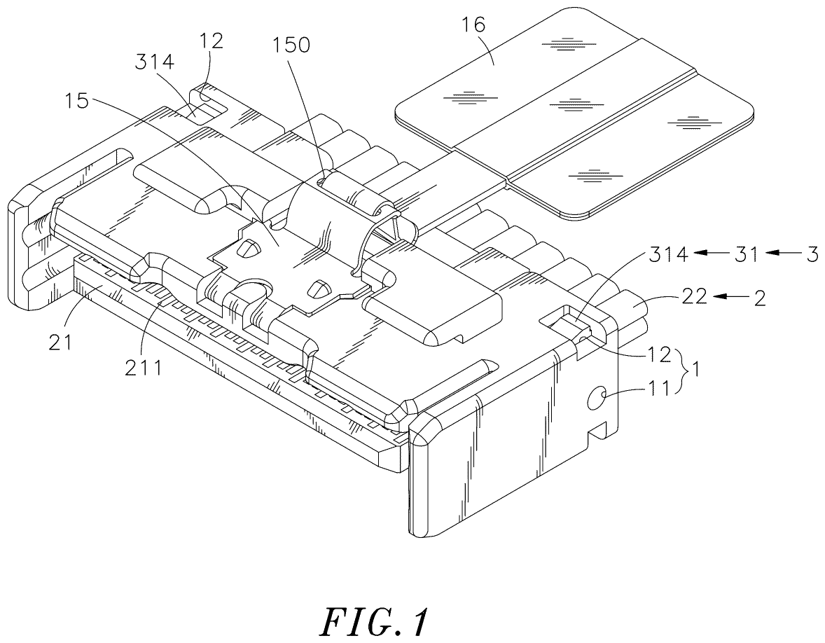

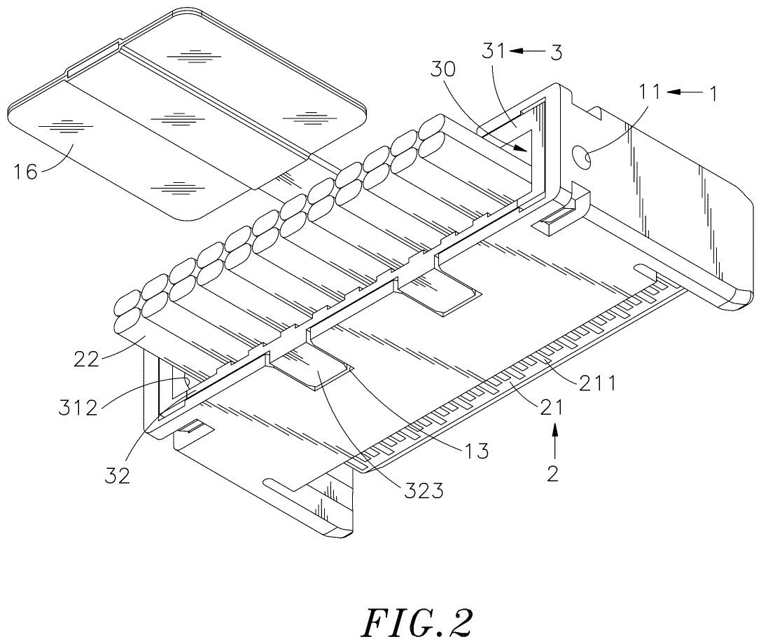

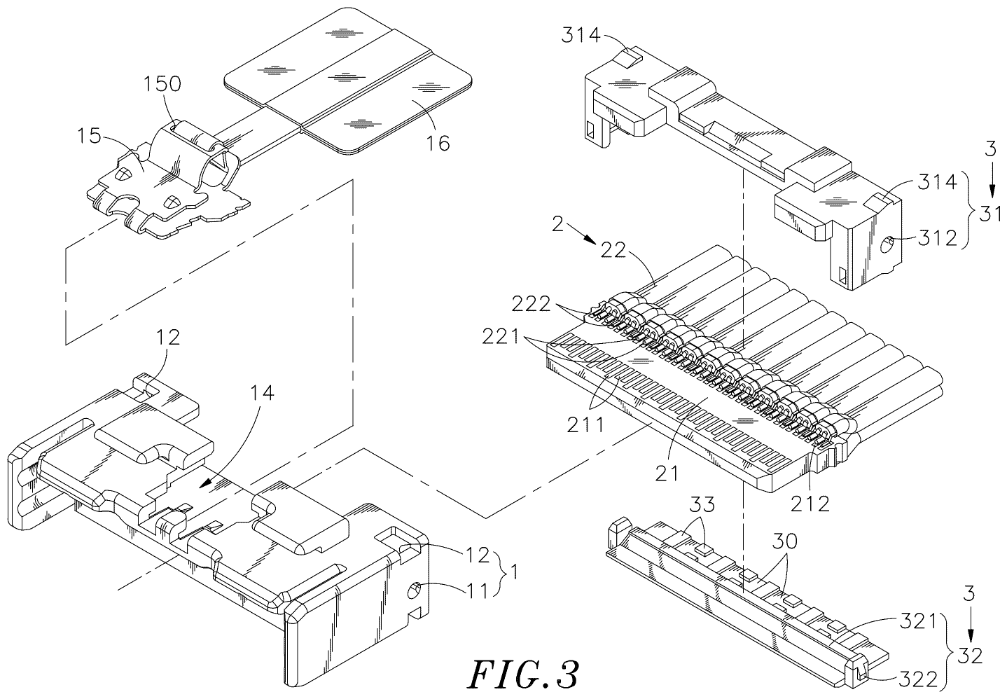

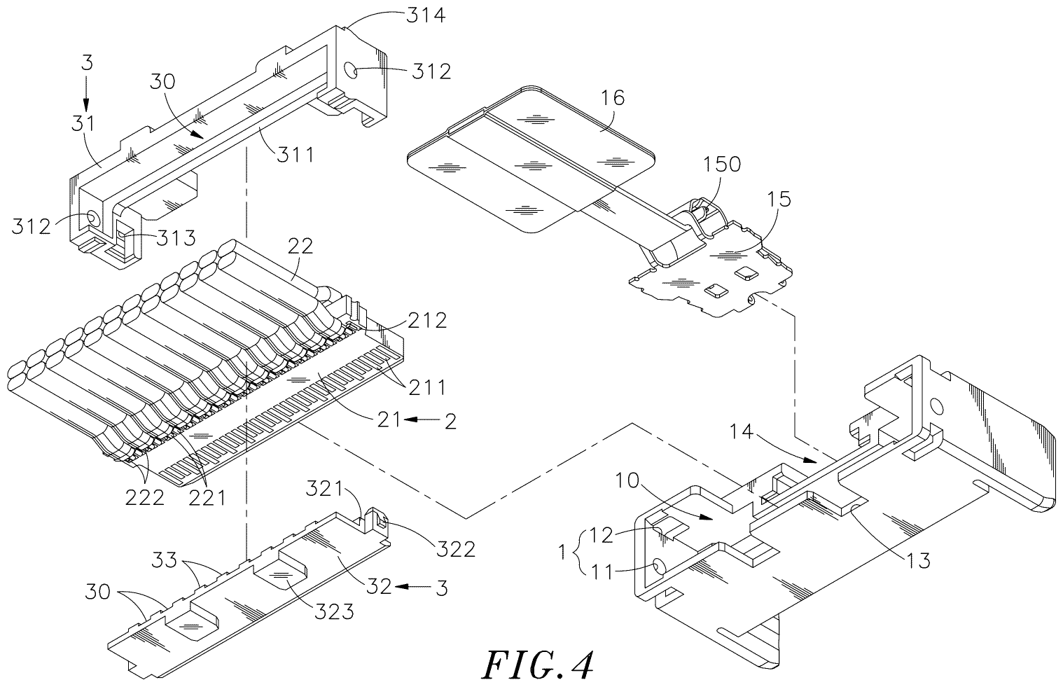

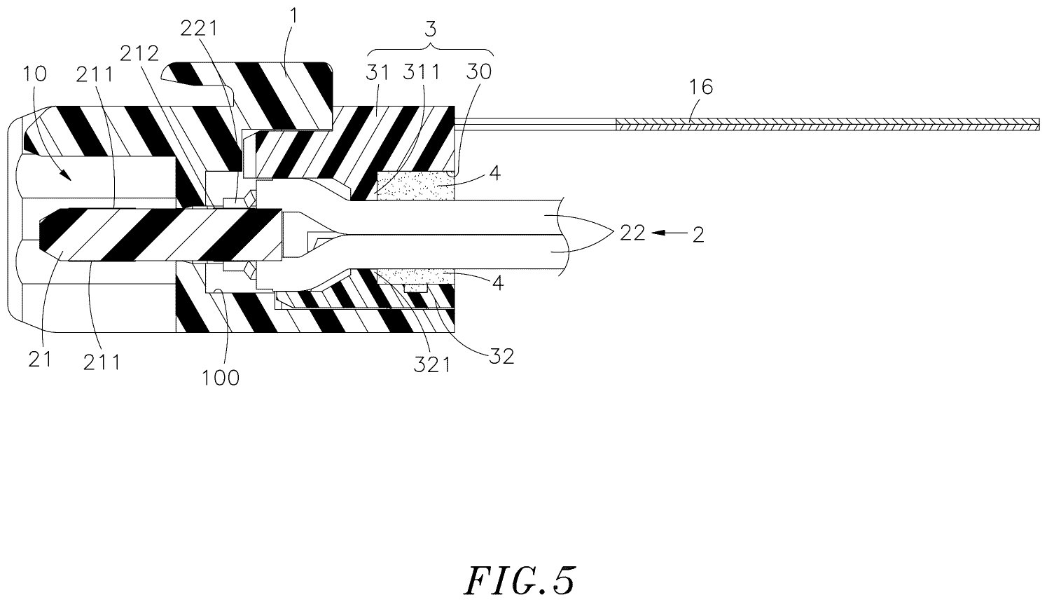

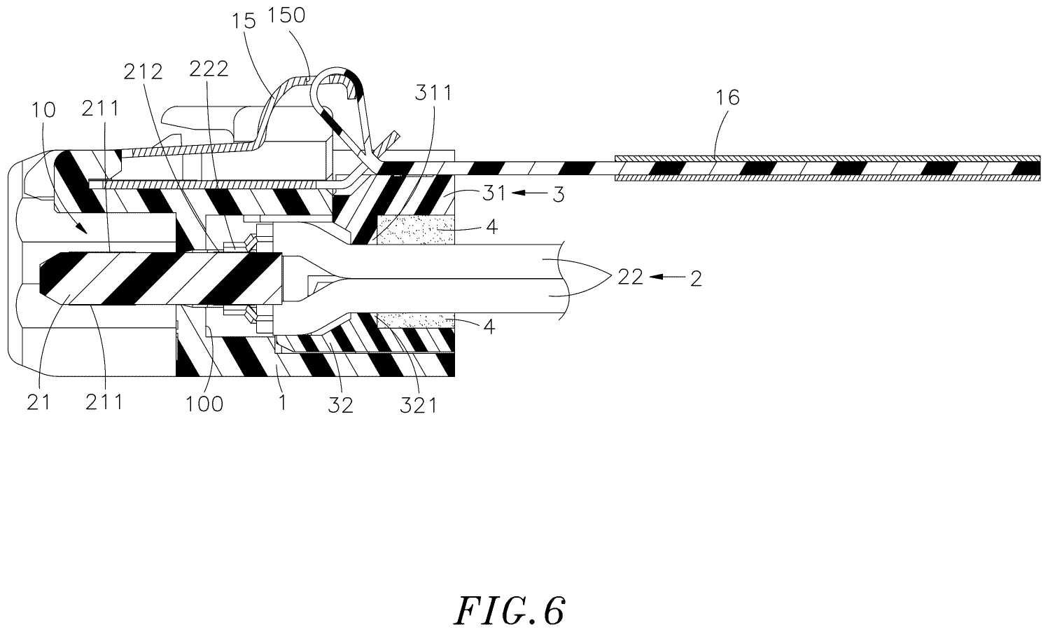

Please refer to FIGS. 1-6, which are respectively a three-dimensional external view, a three-dimensional external view from another viewing angle, a three-dimensional exploded view, a three-dimensional exploded view from another viewing angle, a side cross-sectional view and another side cross-sectional view of the cable connector of the present invention. As can be clearly seen from the figure, the cable connector of the present invention mainly comprises an insulating housing 1 with a storage chamber 10 therein, an electrical module 2 and a clamping shell 3, and the detailed structure and connection relationship are as follows:

The electrical module 2 comprises a circuit board 21, and a plurality of contacts 211 and a plurality of solder pads 212 are disposed on two sides of at least one surface of the circuit board 21. The plurality of solder pads 212 are used for soldering the wire cores of a plurality of cables 22 (including the signal wire cores 221 and the ground wire cores 222).

The clamping shell 3 is disposed outside the electrical module 2. The clamping shell 3 comprises a cover 31 located at the top and a support plate 32 located at the bottom that can be combined with each other. The cover 31 and the support plate 32 respectively have an upper adhesive stopper 311 and a lower adhesive stopper 321 on the inner side thereof, which can prevent the adhesive 4 covering and fixing the plurality of cables 22 from overflowing forward, and a filling area 30 is formed at the back side of the upper adhesive stopper 311 and the lower adhesive stopper 321 for the adhesive 4 to be filled and cured. A hollow area 100 is formed inside the insulating housing 1 at a welding position of the circuit board 21 and the plurality of cables 22 corresponding to the front of the upper adhesive stopper 311 and the lower adhesive stopper 321.

The two sides of the insulating housing 1 are respectively provided with a pouring port 11 and the two sides of the cover 31 are respectively provided with a passage 312 in communication with the pouring port 11 for the adhesive 4 to be injected by the insert molding method. The injected adhesive 4 will flow into the filling area 30 and then will be cured. The insulating housing 1 and the cover 31 are connected and fixed together through at least one fixing groove 12 on the top side of the insulating housing 1 and at least one buckle 314 on the top side of the cover 31. The cover 31 and the support plate 32 are connected and fixed together through the slots 313 on both sides of the cover 31 and the blocks 322 on both sides of the support plate 32. The insulating housing 1 and the support plate 32 are connected and fixed together through at least one buckle groove 13 on the bottom side of the insulating housing 1 and at least one buckle block 323 on the bottom side of the support plate 32. The top side of the insulating housing 1 is provided with a receiving groove 14 and the receiving groove 14 accommodates a locking spring 15 formed of a metal plate. The locking spring 15 has a strap hole 150 on the top side and a pull strap 16 for unlocking is installed in the strap hole 150. The assembly of the cable connector is completed by the aforementioned mutually matching combined fixing structure.

Each of the above-mentioned plurality of cables 22 comprise four wire cores, namely two signal wire cores 221 located at the center and two ground wire cores 222 located at two outer sides. The preferred embodiment of the signal wire cores 221 is differential signal wire cores. Furthermore, the ground wire cores 222 are soldered on the solder pads 212 of the circuit board 21, which can guide the electromagnetic waves generated by the signal wire cores 221 during high-speed transmission of electronic signals to the inner layer of the circuit board 21 (not shown) or the grounding area of other components for elimination, thereby greatly reducing electromagnetic interference (EMI) effects.

The above-mentioned filling area 30 is provided with a plurality of ribs 33 in block or strip shape to increase the adhesion of the adhesive 4. However, the present invention does not limit the configuration of the plurality of ribs 33, and any geometric shape or irregular shape can be used as an implementation structure.

The main feature of the present invention is that when the clamping shell 3 of the cable connector is inserted into the insulating housing 1 for assembly, the upper adhesive stopper 311 and the lower adhesive stopper 321 provided by the cover 31 and the support plate 32 abut against the outside of the plurality of cables 22 to form a sealing structure that can prevent the adhesive 4 of the insert molding method from overflowing forward, so that the cables 22 in the filling area 30 behind the upper adhesive stopper 311 and the lower adhesive stopper 321 can be fixed by the cured adhesive 4. The fixed cables 22 have the effect of improving near-end crosstalk (NEXT) and far-end crosstalk (FEXT) problems. A hollow area 100 is formed at the welding position between the circuit board 21 and the plurality of cables 22 in front of the upper adhesive stopper 311 and the lower adhesive stopper 321, and an area where the signal wire cores 221 are in contact with the air is reserved, so as to control the impedance matching of the electrical connector and reduce the transmission signal attenuation value caused by the insertion loss and the return loss.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the cable connector of the present invention can achieve its effect and purpose when used. Therefore, this invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and we will be very grateful.

What the invention claimed is:

1. A cable connector, comprising an insulating housing with a storage chamber defined therein, an electrical module mounted in said storage chamber and a clamping shell mounted in said storage chamber and located outside said electrical module; wherein:
said electrical module comprises a circuit board, said circuit board being provided with a plurality of contacts and a plurality of solder pads on both sides of at least one surface thereof, said plurality of solder pads being used for soldering wire cores of a plurality of cables;
said clamping shell comprising a cover located at a top side and a support plate located at an opposing bottom side and combined with said cover, said cover comprising an upper adhesive stopper on an inner side thereof, said support plate comprising a lower adhesive stopper on an inner side thereof, said upper adhesive stopper and said lower adhesive stopper defining a filling area at the back side thereof for an adhesive to be filled and cured to cover and fix said plurality of cables that are bonded to said plurality of solder pads, said upper adhesive stopper and said lower adhesive stopper being used to prevent said adhesive covering and fixing said plurality of cables boned to said plurality of solder pads from overflowing forward;
a hollow area is formed inside said insulating housing at a welding position of said circuit board and said plurality of cables at a front side of said upper adhesive stopper and said lower adhesive stopper.

2. The cable connector as claimed in claim 1, wherein said filling area is provided with a plurality of ribs in one of block and strip shapes to increase the adhesion of said adhesive.

3. The cable connector as claimed in claim 1, wherein each of said plurality of cables bonded to said plurality of solder pads comprise four wire cores with two signal wire cores located at the center and two ground wire cores located at two opposite outer sides.

4. The cable connector as claimed in claim 1, wherein said insulating housing further comprises a pouring port located on each of two opposite sides thereof; said cover further comprises a passage located on each of two opposite sides thereof in communication with each said pouring port for said adhesive to be injected into said filling area by an insert molding method.

5. The cable connector as claimed in claim 1, wherein said cover further comprises a plurality of slots respectively located on two opposite sides thereof; said support plate further comprises a plurality of blocks respectively located on two opposite sides thereof and respectively fastened to said plurality of slots to connect and fix said cover and said support plate together.

6. The cable connector as claimed in claim 1, wherein said insulating housing further comprises at least one fixing groove located on a top side thereof; said cover further comprises at least one buckle located on a top side thereof and respectively fastened to said at least one fixing groove to connect and fix said insulating housing and said cover together.

7. The cable connector as claimed in claim 1, wherein said insulating housing further comprises at least one buckle groove located on a bottom side thereof; said support plate further comprises at least one buckle block located on a bottom side thereof and respectively fastened to said at least one buckle groove to connect and fix said insulating housing and said support plate together.

8. The cable connector as claimed in claim 1, wherein said insulating housing further comprises a receiving groove located on a top side thereof, a locking spring formed of a metal plate and accommodated in said receiving groove and provided with a strap hole on a top side thereof, and a pull strap installed in said strap hole for unlocking.
